(19) United States
(12) Patent Application Publication
(10) Pub. No.: US 2007/0245825 A1
(43) Pub. Date: Oct. 25, 2007

(54) Graduated container for dietary portions

(76) Inventor: Stephanie L. Curtis, Aurora, IL (US)

Correspondence Address: Charles F. Meroni, Jr., P.O. Box 309, Barrington, IL, 60011, US

(21) Appl. No.: 11/715,180

(22) Filed: Mar. 7, 2007

Related U.S. Application Data
(60) Provisional application No. 60/794,208, filed on Apr. 21, 2006.

(51) Int. Cl. G01F 19/00

(52) U.S. Cl. 73/426

(57) ABSTRACT

A “portion-smart” graduated container enables a user to accurately measure dietary portions and consume the same from the “portion-smart” container. The graduated container comprises an inner container surface, an outer container surface, a container rim, a container bottom, and a container wall. The inner container surface at the container wall comprises graduated markings and is designed to receive dietary portions intermediate the container rim, container wall, and container bottom. The graduated markings are user-viewable via the container rim for enabling the user to volumetrically measure received dietary portions. The dietary portions are removable from the graduated container during a mealtime and the “portion-smart” graduated container thus enables the user to dole out dietary portions.

### PRIOR HISTORY

This non-provisional application claims the benefit of U.S. Provisional Patent Application No. 60/794,208, filed in the United States Patent and Trademark Office on April 21, 2006.

### FIELD OF THE INVENTION

The invention generally relates to a device for precisely measuring consumable ingredients as targeted for meal-time consumption. More particularly, the present invention relates to a “portion-smart” container for doling out accurate dietary portions and for enabling the consumer to consume the portions directly from the container.

### DESCRIPTION OF THE PRIOR ART

Diet aids are well-known in the arts having been developed out of an appreciation for the fact that the dieting process can often be difficult for those who desire to lose weight. Noting that portion size consistency is key to successful dieting, diet aids directed to more accurately measuring out portions have been developed. Measuring cups, for example, are often utilized to correctly dole out portions. The use of a plurality of measuring cups, however, is often viewed as a hassle at meal time, resulting in the creation of added effort, including filling and emptying various measuring cups and having to clean and maintain the measuring cups following their use. Further, if the user is utilizing a single conventional graduated measuring cup, he or she must often clean the cup between ingredient fills during a single meal preparation. In an effort to alleviate the hassles involved with using conventional measuring cups, dieters often guess or estimate portion sizes, thereby foiling the original purpose of the measuring cup, and otherwise making the dieting process more difficult.

Conventional measuring cups are often designed as vessels from which one would not normally directly consume the measured portion. In other words, measuring cups are utilized to accurately measure a portion, which portion is then transferred to the vessel from which the consumer partakes of the consumable. Measuring cups are generally not aesthetically pleasing or configured for dietary intake, but rather are designed for accurately measuring consumable portions. Food transfer(s) and the like contribute to added effort for the dieter, and consuming portions directly from a measuring cup may add stigma to the dieting situation, further handicapping the would-be dieter. It will be recalled that the dieter may well capitalize upon every diet-facilitating device available so as to maximize the goal of weight loss. In this regard, the prior art thus perceives a need for a so-called “portion-smart” bowl or cup that will function to simultaneously enable the user to dole out proper portions and consume the doled out portions directly from the graduated vessel.

### SUMMARY OF THE INVENTION

It is thus an object of the present invention to provide a graduated consumable container that enables the consumer to dole out accurately-sized portions consumable directly from the container without signaling to passersby that the consumer is eating/drinking from a diet-facilitating device. To achieve these and other readily apparent objectives, the present invention essentially discloses a “Portion-Smart” bowl, cup or similar other container, whereby the consumer may achieve correct portions of food directly in the container(s) being used to contain food to be consumed during a given meal or “meal-consumed”.

By offering bowls, cups, and/or similar other containers with graduated lines located on the interior of the container(s), the containers may effect an attractive appearance at a table setting while allowing the dieter to know exactly how much of a beverage or food they are consuming. An alternative version may be manufactured with the measurement quantities designated on the exterior, as well. In addition to controlling portion size, a user who does not finish the portion, may easily calculate the unconsumed portion via the graduated markings. It is contemplated that cups, bowls and similar other containers of the present invention may be provided in various sizes, shapes, colors, motifs, or decorations as desired. It is contemplated that the graduated markings may incorporate conventional or traditional measuring cup increments, such as ¼ cup, ⅓ cup, ½ cup, ¾ cup, 1 cup, etc.

### BRIEF DESCRIPTION OF THE DRAWINGS

Other features of my invention will become more evident from a consideration of the following brief description of patent drawings:

FIG. 1 is a top perspective view of a first bowl of the present invention showing a user-viewable portion of the container wall with stepped graduated markings on the interior surface of the first bowl and an ornate exterior surface of the first bowl.

FIG. 2 is a fragmentary cross-sectional side view of the first bowl otherwise shown in FIG. 1 showing the user-viewable portion of the container wall with stepped graduated markings on the interior surface of the first bowl and an ornate exterior surface of the first bowl.

FIG. 3 is a top perspective view of a second bowl of the present invention showing a user-viewable portion of the container wall with peripheral graduated markings on the interior surface of the second bowl and an ornate exterior surface of the second bowl.

FIG. 4 is a cross-sectional side view of the second bowl otherwise shown in FIG. 3 showing the user-viewable portion of the container wall with peripheral graduated markings on the interior surface of the second bowl.

FIG. 5 is a top perspective view of a third bowl of the present invention showing stepped graduated markings on the exterior surface of the third bowl.

FIG. 6 is a side plan view of the third bowl otherwise shown in FIG. 5 showing stepped graduated markings on the exterior surface of the third bowl.

FIG. 7 is a top perspective view of a first cup of the present invention showing stepped graduated markings on the exterior surface of the first cup.

FIG. 8 is a side plan view of the first cup otherwise shown in FIG. 7 showing stepped graduated markings on the exterior surface of the first cup.

FIG. 9 is a top perspective view of a second cup of the present invention showing peripheral graduated markings on the exterior surface of the second cup.

FIG. 10 is a side plan view of the second cup otherwise shown in FIG. 9 showing peripheral graduated markings on the exterior surface of the second cup.

FIG. 11 is a top perspective view of the first bowl of the present invention showing an onlooker-viewable portion of the inner container wall and an ornate exterior surface of the first bowl.

FIG. 12 is a fragmentary cross-sectional side view of the first bowl otherwise shown in FIG. 11 showing the onlooker-viewable portion of the inner container wall and an ornate exterior surface of the first bowl.

FIG. 13 is a top perspective view of the second bowl of the present invention showing a user-viewable portion of the container wall with peripheral graduated markings on the interior surface of the second bowl, a dietary portion received to otherwise visually obscure the 1¼ graduated marking on the interior surface, and an ornate exterior surface of the second bowl.

FIG. 14 is a cross-sectional side view of the second bowl otherwise shown in FIG. 13 showing the user-viewable portion of the container wall with peripheral graduated markings on the interior surface of the second bowl and the dietary portion received to otherwise visually obscure the 1¼ graduated marking on the interior surface.

FIG. 15 is a cross-sectional side view of a third bowl showing a conically shaped inner container surface with a smooth profile, the user-viewable portion of the container wall comprising peripheral graduated markings.

FIG. 16 is a cross-sectional side view of a fourth bowl showing a conically shaped inner container surface with a stepped profile, the user-viewable portion of the container wall comprising peripheral graduated markings.

FIG. 17 is an enlarged fragmentary perspective sectional view of the fourth bowl otherwise shown in FIG. 16 showing a conically shaped inner container surface with a stepped profile.

### DETAILED DESCRIPTION OF THE PREFERRED EMBODIMENT(S)

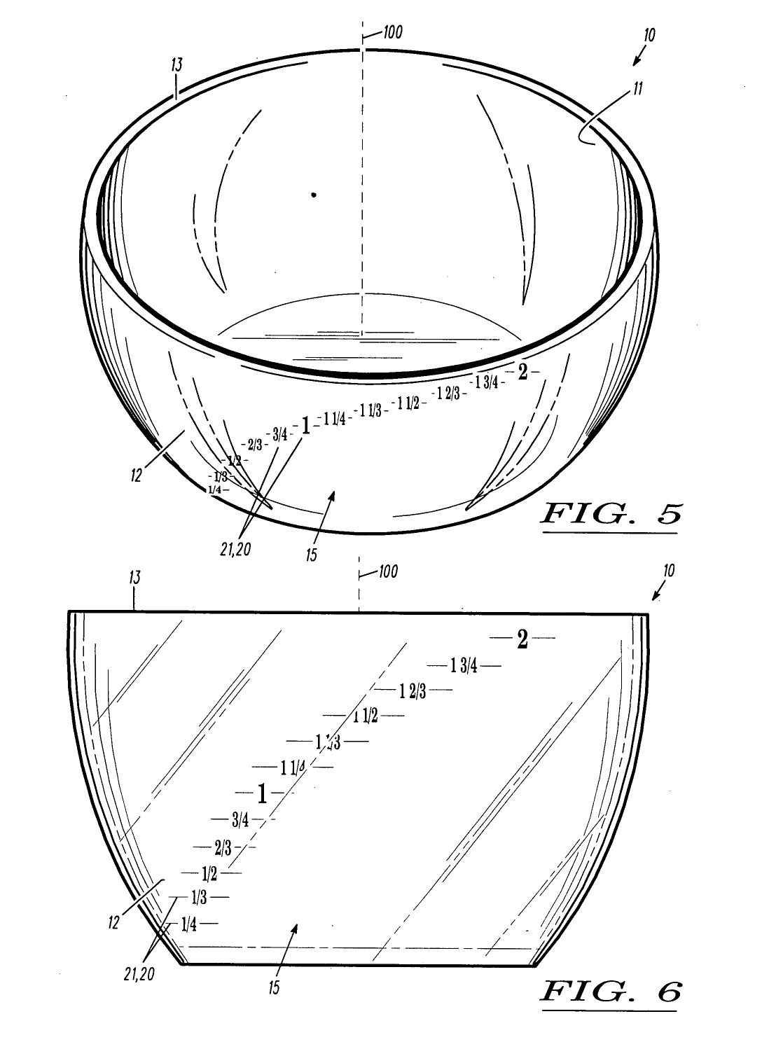

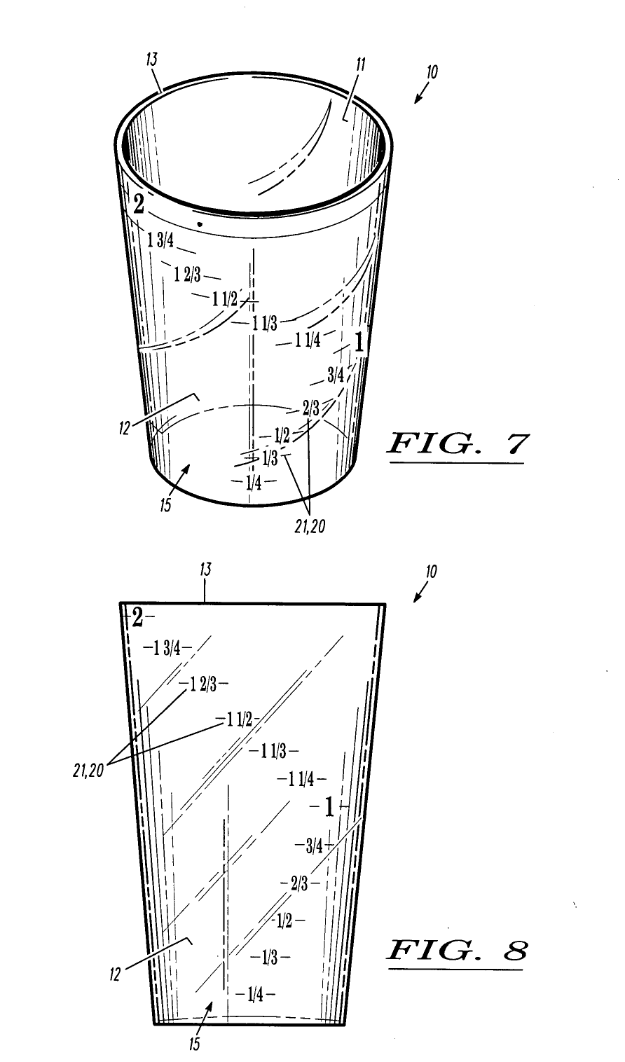

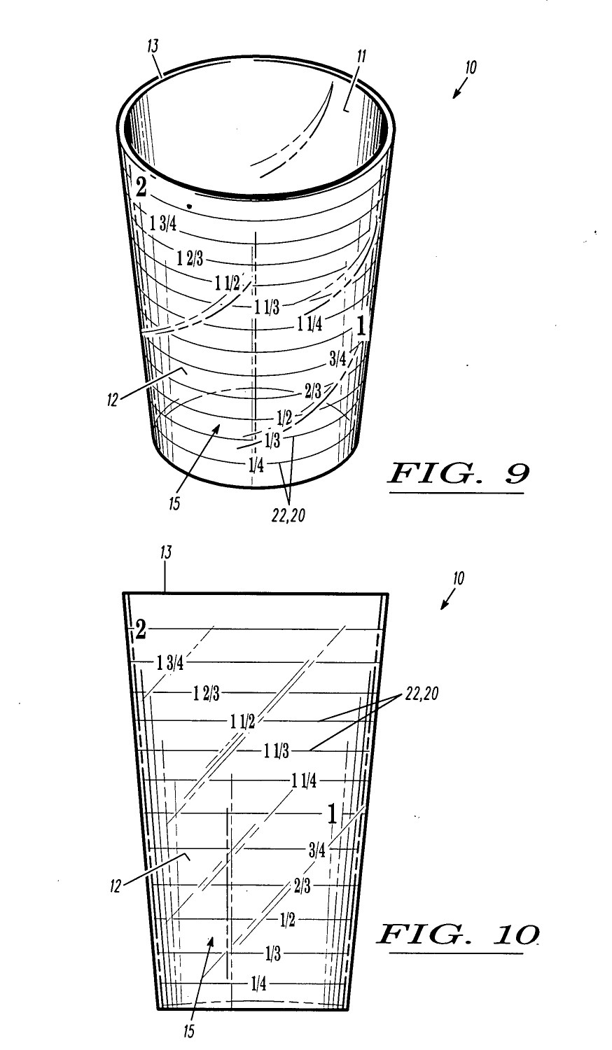

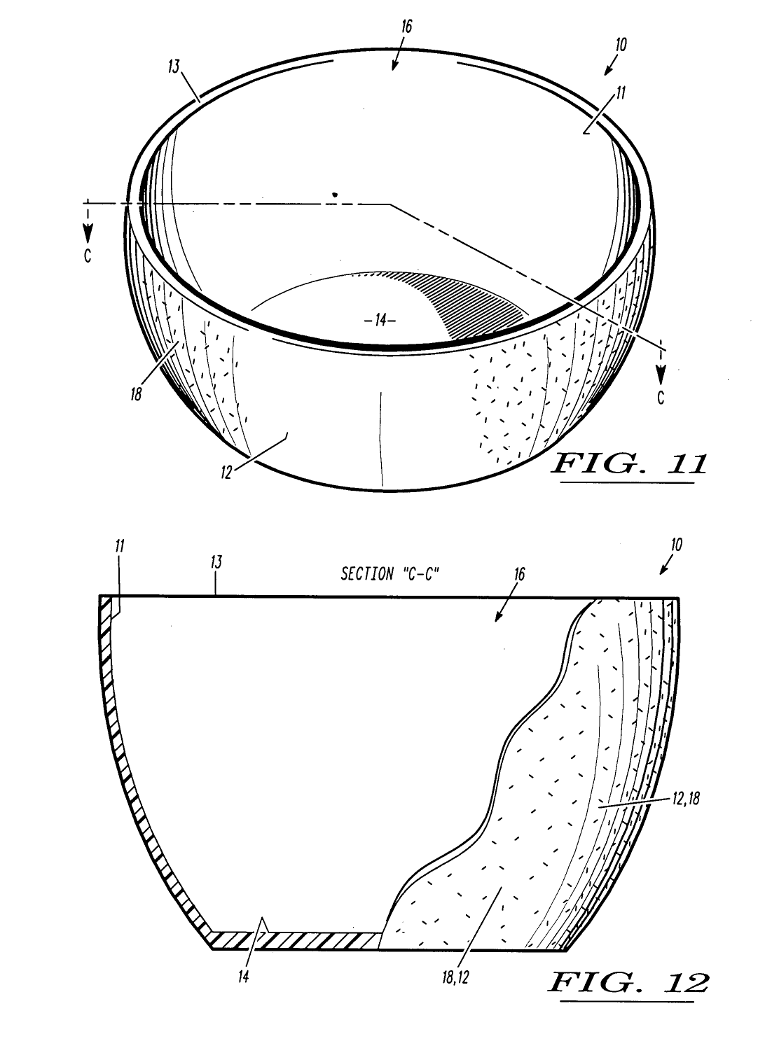

Referring now to the drawings, the preferred embodiment of the present invention generally concerns a graduated container 10 (preferably configured in the form of a bowl 30 as generally depicted in FIGS. 1-6 and 11-14 or in the form of a cup 40 as generally depicted in FIGS. 7-10) for doling out dietary portions as generally illustrated and referenced in FIGS. 1-14, inclusive. It is contemplated that in a first preferred embodiment, the graduated container 10 is preferably constructed from an opaque material such as ceramic, polymer, metal, wood, or composite, and preferably comprises an inner container surface as at 11 in FIGS. 1-5, 7, 9, and 11-14; an outer container surface as at 12 in FIGS. 1-14; a container rim as at 13 in FIGS. 1-14; a container bottom as at 14 in FIGS. 1-5, 11, 12, and 14; a user-viewable container wall portion as generally referenced at 15 in FIGS. 1-10, 13, and 14; an onlooker-viewable container wall portion as generally referenced at 16 in FIGS. 11 and 12; a longitudinal container axis as generally referenced at 100 in FIGS. 5 and 6; and a transverse container dimension as generally depicted in the evenly numbered figures of the drawings attached hereto. Together, container wall portions 15 and 16 comprise a single container wall.

It may be seen from a comparative inspection of Figure Nos. FIGS. 1-10, 13, and 14 versus FIGS. 11 and 12 that the user-viewable container wall portion 15 and the onlooker-viewable container wall portion 16 are opposed to one another. In this regard, it is noted that when the container rim 13 is rotated or otherwise positioned about the container axis 100 for enabling a user to view the user-viewable container wall portion 15, the inner container surface 11 at the user-viewable container wall portion 15 comprises graduated markings as at 20 in FIGS. 1-4, 13, and 14. In other words, when the user positions the container 10 for use, those portions viewable to the user are typically obscured from view from passersby or onlookers, the passersby or onlookers generally being juxtaposed opposite or adjacent the user.

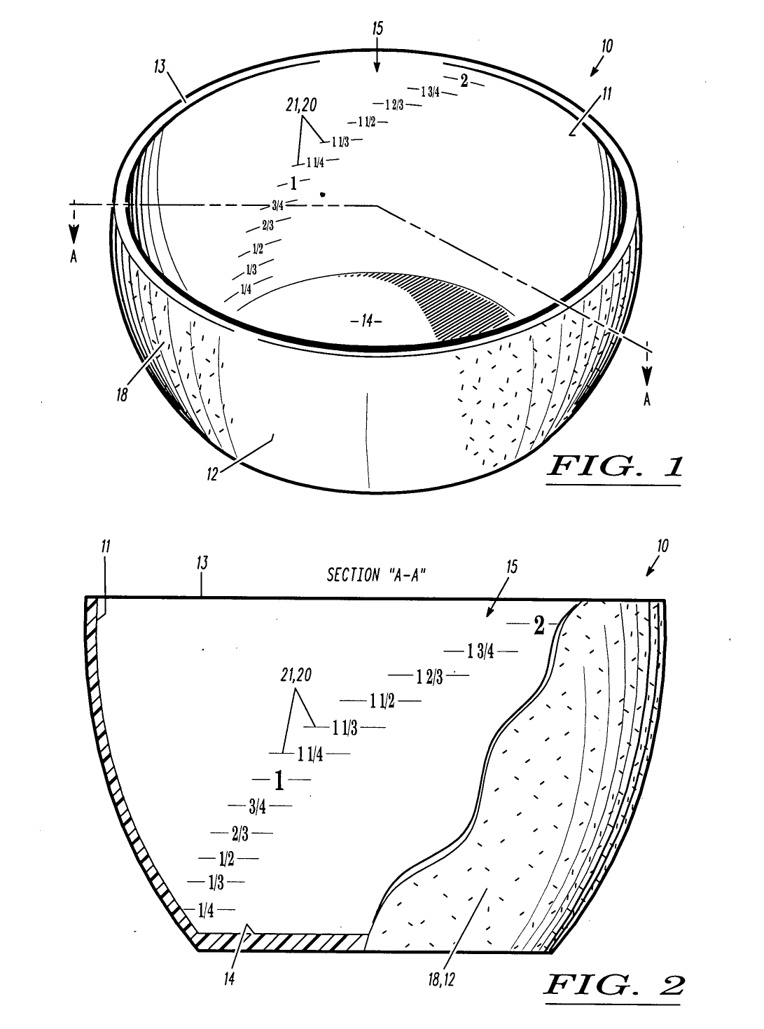

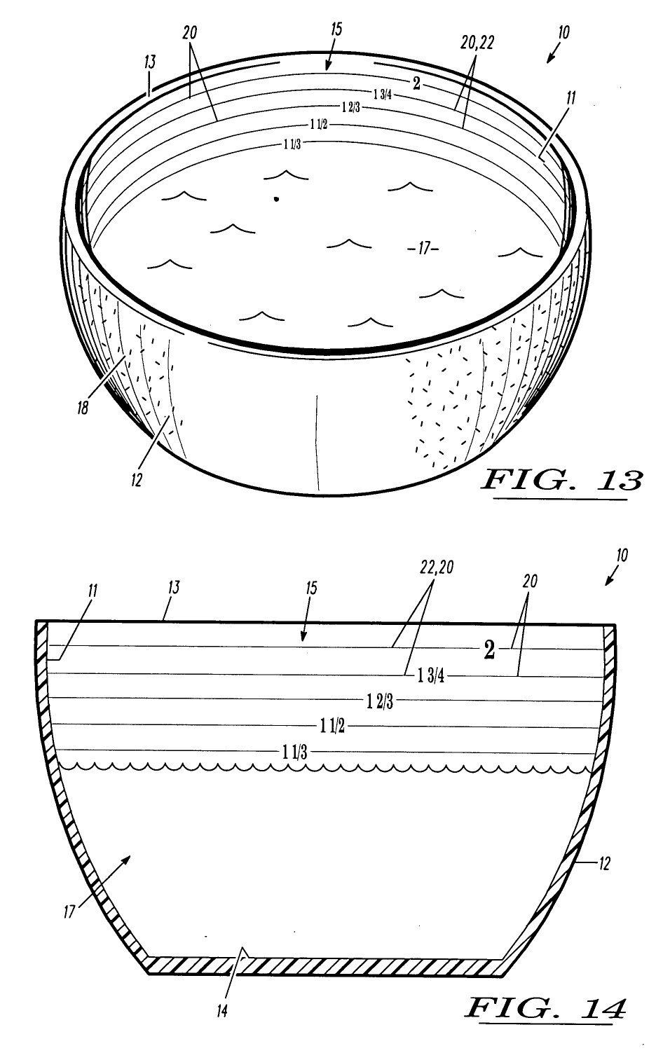

The inner container surface 11 essentially functions to receive and position dietary portion(s) as at 17 in FIGS. 13 and 14 intermediate the container rim 13, the container wall portions 15 and 16 and the container bottom 14. The graduated markings 20 are thus user-viewable via the container rim 13 as viewed at an angle intermediate the longitudinal container axis 100 and the transverse dimension (i.e. being top-perspectively viewable as in the oddly numbered figures of this description) for enabling the user to volumetrically measure received dietary portion(s) 17. The opaque material of the graduated container essentially functions to visually obscure the received dietary portion(s) 17 and the graduated markings 20 from extreme lateral view in the transverse container dimension. In this regard, it may be seen from an inspection of FIGS. 2 and 12 that certain portions of the graduated container have been broken away so as to enable viewing of the opposite wall from an extreme lateral or transverse dimension. The dietary portion(s) 17 are further removable from the graduated container 10 during a mealtime, and thus, it is contemplated that the graduated container 10 of the present invention may well function to enable a user to dole out dietary portion(s) 17.

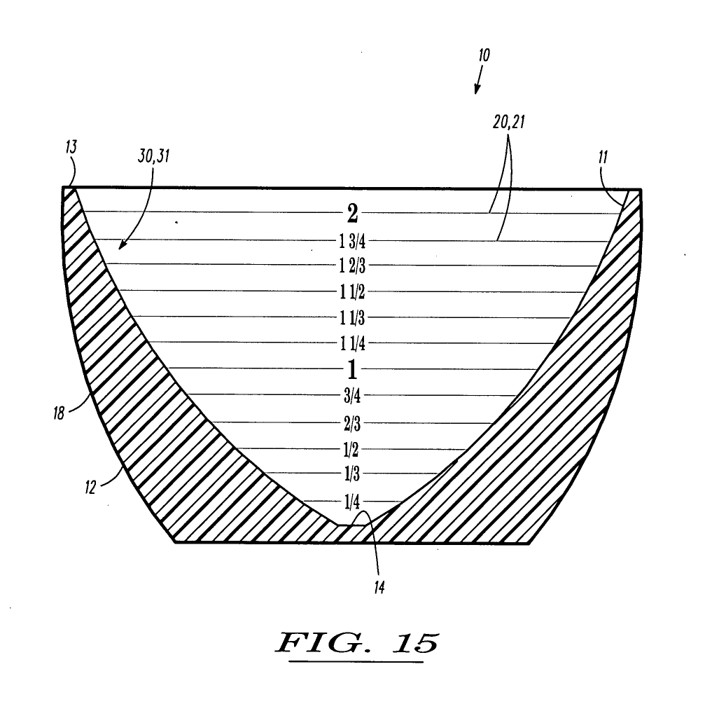

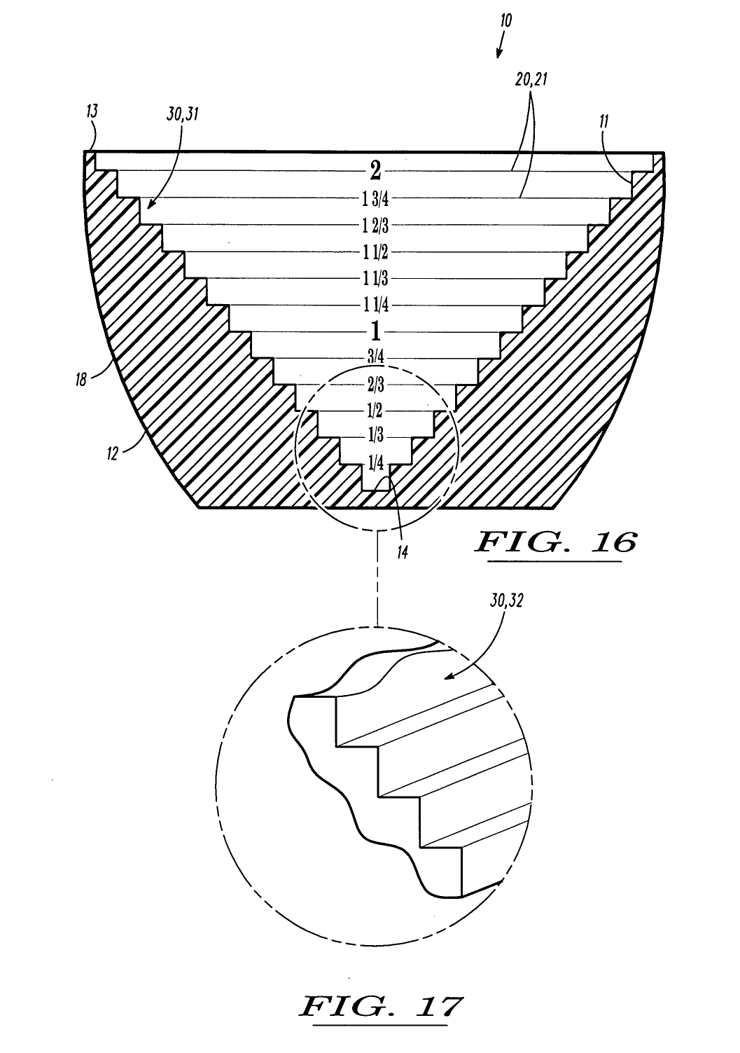

From an inspection of FIGS. 15-17, it may be seen that the inner container surface 11 of the graduated container 10 may preferably be conically shaped as at 30. It is contemplated that the conically-shaped inner container surface 11 may be made with a smooth profile 31 as generally depicted and referenced in FIG. 15 or with a stepped profile 32 as generally depicted and referenced in FIGS. 16 and 17. In this last regard, it is contemplated that the conically-shaped inner container surface 11 may well function to enhance the measured accuracy of the doled out dietary portions insofar as volumetric portions of conics are readily ascertainable. With regard to the stepped profile of the conically shaped inner container surface, it is contemplated that the same may well function to enhance a user's ability to dole out dietary portions with enhanced measured accuracy. In other words, it is contemplated that when a dietary portion becomes level with a step of the stepped profile, the doled out dietary portion is measured with the aid of background structure in addition to background indicia. The combination of background structure and indicia to measure doled out portions is thus thought preferable and may well enhance the utility of the graduated container 10.

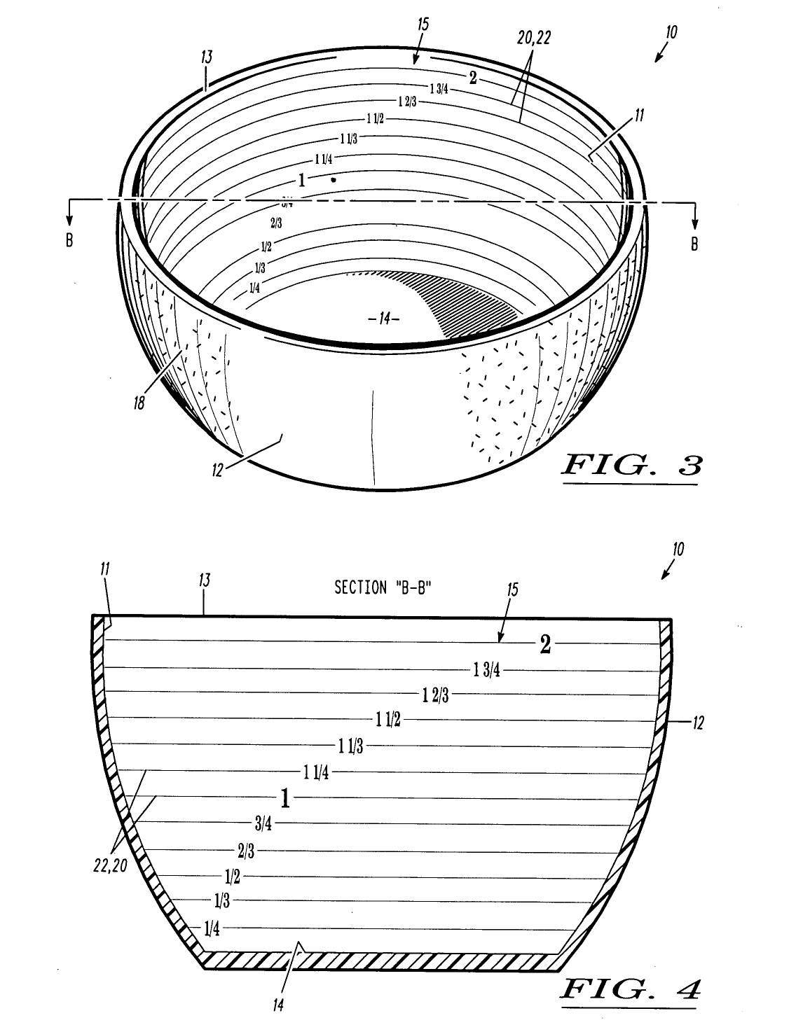

It may be seen from a comparative inspection of FIGS. 1, 2, and 5-8 versus FIGS. 3, 4, 9, 10, 13, and 14 that the graduated container 10 of the present invention may preferably comprise either stepped graduated markings as at 21 (in FIGS. 1, 2, and 5-8) or transversely peripheral graduated markings as at 22 (in FIGS. 3, 4, 9, 10, 13, and 14). When stepped graduated markings 21 are incorporated into the design, it is contemplated that the preferred arrangement thereof is diagonal as generally depicted in the noted figures. It is contemplated that the stepped graduated markings 21 and the transversely peripheral graduated markings 22 extend intermediate the container bottom 14 and the container rim so as to enhance the user's ability to volumetrically measure received dietary portion(s) 17.

It is further contemplated that the outer container surface 12 of the graduated container 10 may preferably comprise certain ornamentation, such as being vibrantly colored or being decorated as at 18 in FIGS. 1-3 and 11-13. In this regard, it is contemplated that the ornamentation 18 or ornamental nature of the outer container surface 12 may well function to drawing onlookers' attention(s) away from the inner container surface 11, the graduated markings 20, the dietary portion(s) 17, etc. toward the outer container surface 12 as a means to enhance the user's confidence while ingesting from the graduated container 10.

In a second preferred embodiment of the present invention it is contemplated that the graduated container 10 may be preferably constructed from a normally translucent material such as certain glass or polymeric material. In this regard, it should be noted that that the translucent material may be of substantially transversely translucent type wherein only normal (i.e. perpendicular to the container axis 100) viewing of the graduated markings is clearly enabled. In other words, it is contemplated that while wherein the translucent material is substantially transversely translucent, the material may well function to visually obscure the dietary portion(s) 17 and the graduated markings 20 from views having dimension in the axial direction of container axis 100.

While the foregoing specifications delineate much specificity, the same should not be construed as limiting the invention, but as providing a backdrop from which the essence of the present invention emerges. Thus, although the invention has been described by reference to a number of preferred embodiments, and the advantages thereof set forth, it is not intended that the novel embodiments be limited thereby, but that modifications thereof are intended to be included as falling within the broad scope and spirit of the foregoing disclosure and the appended drawings.

I claim:

1. A graduated container for enabling a user to dole out dietary portions, the graduated container being constructed from an opaque material and comprising an inner container surface, an outer container surface, a container rim, a container bottom, a user-viewable container wall, an onlooker-viewable container wall, a longitudinal container axis, and a transverse container dimension, the user-viewable and onlooker-viewable container walls being opposed to one another, the container rim being rotatable about the container axis for enabling a user to view the user-viewable container wall, the inner container surface at the user-viewable container wall comprising graduated markings, the inner container surface for receiving dietary portions intermediate the container rim, container wall, and container bottom, the graduated markings thus being user-viewable via the container rim at an angle intermediate the longitudinal container axis and the transverse dimension for enabling the user to-volumetrically measure received dietary portions, the opaque material for visually obscuring the received dietary portions and the graduated markings from extreme lateral view in the transverse container dimension, the dietary portions being removable from the graduated container during a mealtime, the graduated container thus for enabling the user to dole out dietary portions.

2. The graduated container of claim 1 wherein the inner container surface is conically shaped, the conically-shaped inner container surface for enhancing the measured accuracy of the doled out dietary portions.

3. The graduated container of claim 2 wherein the graduated markings are stepped upon the user-viewable container wall intermediate the container bottom and the container rim for enhancing the user's ability to volumetrically measure received dietary portions.The graduated container of claim 1 wherein the graduated markings are stepped upon the user-viewable container wall intermediate the container bottom and the container rim for enhancing the user's ability to volumetrically measure received dietary portions.

4. The graduated container of claim 3 wherein the conically shaped inner container surface comprises a stepped profile, the stepped profile of the conically shaped inner container surface for enhancing a user's ability to dole out dietary portions with enhanced measured accuracy.

5. The graduated container of claim 4 wherein the graduated markings are diagonally stepped for enhancing the user's ability to volumetrically measure received dietary portions.

6. The graduated container of claim 5 wherein the outer container surface comprises ornamentation, the ornamentation for drawing onlookers' attention away from the inner container surface toward the outer container surface.

7. A graduated container for doling out dietary portions, the graduated container comprising an inner container surface, an outer container surface, a container rim, a container bottom, a container wall, a longitudinal container axis, and a transverse container dimension, the container rim being rotatable about the container axis for enabling a user to view the container wall, the inner container surface at the container wall comprising graduated markings, the inner container surface for receiving dietary portions intermediate the container rim, container wall, and container bottom, the graduated markings thus being user-viewable via the container rim intermediate the longitudinal container axis and the transverse dimension for enabling the user to volumetrically measure received dietary portions, the dietary portions being removable from the graduated container during a mealtime, the graduated container thus for enabling the user to dole out dietary portions.

8. The graduated container of claim 7 wherein the inner container surface is conically shaped, the conically-shaped inner container surface for enhancing the measured accuracy of the doled out dietary portions.

9. The graduated container of claim 8 wherein the conically shaped inner container surface comprises a stepped profile, the stepped profile of the conically shaped inner container surface for enhancing a user's ability to dole out dietary portions with enhanced measured accuracy.

10. The graduated container of claim 8 wherein the graduated markings are transversely peripheral upon the container wall intermediate the container bottom and the container rim for enhancing the user's ability to volumetrically measure received dietary portions.

11. The graduated container of claim 8 being constructed from an opaque material, the opaque material for visually obscuring the received dietary portions and the graduated markings from extreme lateral view in the transverse container dimension.

12. The graduated container of claim 8 wherein the outer container surface comprises ornamentation, the ornamentation for drawing onlookers' attention away from the inner container surface toward the outer container surface.

13. A graduated container for doling out dietary portions, the graduated container being constructed from an translucent material and comprising a inner container surface, an outer container surface, a container rim, a container bottom, a user-viewable container wall, an onlooker-viewable container wall, a longitudinal container axis, and a transverse container dimension, the user-viewable and onlooker-viewable container walls being opposed to one another, the container rim being rotatable about the container axis for enabling the user to view the user-viewable container wall, the outer container surface at the user-viewable container wall comprising graduated markings, the inner container surface for receiving dietary portions intermediate the container rim, container wall, and container bottom, the graduated markings being user-viewable for enabling the user to volumetrically measure received dietary portions, the dietary portions being removable from the graduated container during a mealtime, the graduated container thus for enabling the user to dole out dietary portions.

14. The graduated container of claim 13 wherein the inner container surface is conically shaped, the conically-shaped inner container surface for enhancing the measured accuracy of the doled out dietary portions.

15. The graduated container of claim 14 wherein the conically shaped inner container surface comprises a stepped profile, the stepped profile of the conically shaped inner container surface for enhancing a user's ability to dole out dietary portions with enhanced measured accuracy.

16. The graduated container of claim 14 wherein the translucent material is transversely translucent, the transversely translucent material for visually obscuring the dietary portions and the graduated markings from views having dimension in the container axial direction.

17. The graduated container of claim 14 wherein the graduated markings are stepped upon the user-viewable container wall intermediate the container bottom and the container rim for enhancing the user's ability to volumetrically measure received dietary portions.

18. The graduated container of claim 17 wherein the graduated markings are diagonally stepped for enhancing the user's ability to volumetrically measure received dietary portions.

19. The graduated container of claim 14 wherein the graduated markings are transversely peripheral for enhancing the user's ability to volumetrically measure received dietary portions.

20. The graduated container of claim 14 wherein the outer container surface comprises visually perceptive ornamentation, the visually perceptive ornamentation for drawing onlookers' attention away from the graduated markings.
